(19) United States
(12) Patent Application Publication
(10) Pub. No.: US 2009/0265203 A1
(43) Pub. Date: Oct. 22, 2009

(54) USER PRIORITIZED SEARCH ENGINE FOR AUTOMATED MEETING SCHEDULING

(76) Inventors: Jane B. Marcus, Westford, MA (US); Irina Khasin, Acton, MA (US); Nancy E. Kho, Belmont, MA (US); Terri A. Warren, Hampton, NH (US)

Correspondence Address: HOFFMAN WARNICK LLC, 75 STATE STREET, 14TH FLOOR, ALBANY, NY, 12207, US

(21) Appl. No.: 12/104,565

(22) Filed: Apr. 17, 2008

(51) Int. Cl. G06Q 90/00; G06F 17/30

(52) U.S. Cl. 705/8; 707/3

(57) ABSTRACT

The present solution provides a new concept of ranking whereby calendar users will be allowed to prioritize a variety of meeting attributes. For prioritizing their meeting requirements, users can place meeting requirements into one of two lists: “Must/mandatory” and “preferred.” The system will then search for meeting times that satisfy the user's prioritization. The search produces a ranked result set of meeting alternatives. Users see percentage rankings of how well the various meeting alternatives satisfy their Must and preferred requirements, and a summary of proposed meeting logistics for each alternative.

### FIELD OF THE INVENTION

The present invention generally relates to search engine technology. Specifically, then present invention allows search engine technology to be leveraged through user prioritization in the automated scheduling of meetings.

### BACKGROUND OF THE INVENTION

In the corporate environment, the scheduling of meetings can be a challenging and time intensive procedure, due to limited availability of people and resources. The people you need to invite to a meeting invariably have very full calendars, and you, the user, will find it cumbersome to locate optimal dates and times to invite others to a meeting. Scheduling conflicts are extremely common, and yet conventional tools do very little to help you manage scheduling issues. Scheduling software should provide greater assistance to find meeting times which are convenient for you and your invitees, and the procedures to schedule meetings should not take so much of your time.

Calendar applications often support a variety of features, but these applications generally do not have extensive capability to deal with error scenarios such as when an invitee, a location, or equipment is unavailable. A sample problem scenario arises when you attempt to schedule a meeting and you pick a day or time when your invitees are not available. Many calendar applications, can track each person's availability, so that the software can easily determine whether a particular person might be free to attend your meeting at a given date/time. In this case, the software might tell you which invitees are not available at the time you've chosen and also perhaps show you an overview of when the invitees are busy versus free. In the case of products that investigate the busy versus free time of invitees, it is left largely as an exercise for a user to look for patterns of free time across all invitees. Likewise, certain software products can visually display the availability of conference rooms and resources. However, when scheduling conflicts arise, the software leaves it up to the user to manually look at the data representation to determine best availability or any other error condition that might arise. In view of the foregoing, there exists a need for a solution that solves at least one of the problems of the related art.

### SUMMARY OF THE INVENTION

In today's busy world, scheduling meetings is one of the most common tasks. Many of the current calendaring software programs allow multiple criteria when scheduling meetings: Date, Time, Meeting length, Critical and Optional Attendees, Rooms, Resources, even color coding of categories for types of meetings. What is missing is a ranking system for meeting criteria. The present solution provides a new concept of ranking whereby calendar users will be allowed to prioritize a variety of meeting attributes. For prioritizing their meeting requirements, users can place meeting requirements into one of two lists: “Must/mandatory” and “preferred.” The system will then search for meeting times that satisfy the user's prioritization. The search produces a ranked resultant set of meeting alternatives. Users see percentage rankings of how well the various meeting alternatives satisfy their Must and preferred requirements, and a summary of proposed meeting logistics for each alternative. In conducting the search, the system will have comprehensively consulted with all external systems which may be involved in meeting scheduling, which saves much time for the user by providing a one-stop shopping experience. The user then can follow-up by choosing the most suitable alternative from the results set to actually schedule the meeting.

A first aspect of the present invention provides a method for scheduling a meeting, comprising: receiving a set of meeting characteristics; receiving a first list having a set of mandatory meeting characteristics that are required for the meeting, an order of the set of mandatory meeting characteristics in the first list dictating their prioritization when scheduling the meeting; receiving a second list having a set of preferred meeting characteristics that are optional for the meeting, an order of the set of preferred meeting characteristics in the second list dictating their prioritization when scheduling the meeting; and scheduling the meeting using the first list and the second list.

A second aspect of the present invention provides a system for scheduling a meeting, comprising: a module for receiving a set of meeting characteristics; a module for receiving a first list having a set of mandatory meeting characteristics that are required for the meeting, an order of the set of mandatory meeting characteristics in the first list dictating their prioritization when scheduling the meeting; a module for receiving a second list having a set of preferred meeting characteristics that are optional for the meeting, an order of the set of preferred meeting characteristics in the second list dictating their prioritization when scheduling the meeting; and a module for scheduling the meeting using the first list and the second list.

A third aspect of the present invention provides a computer readable medium containing a program product for scheduling a meeting, the computer readable medium comprising program code for causing a computer system to comprising: receive a set of meeting characteristics; receive a first list having a set of mandatory meeting characteristics that are required for the meeting, an order of the set of mandatory meeting characteristics in the first list dictating their prioritization when scheduling the meeting; receive a second list having a set of preferred meeting characteristics that are optional for the meeting, an order of the set of preferred meeting characteristics in the second list dictating their prioritization when scheduling the meeting; and schedule the meeting using the first list and the second list.

A fourth aspect of the present invention provides a method for deploying an application for scheduling a meeting, comprising: providing a computer infrastructure being operable to: receive a set of meeting characteristics; receive a first list having a set of mandatory meeting characteristics that are required for the meeting, an order of the set of mandatory meeting characteristics in the first list dictating their prioritization when scheduling the meeting; receive a second list having a set of preferred meeting characteristics that are optional for the meeting, an order of the set of preferred meeting characteristics in the second list dictating their prioritization when scheduling the meeting; and schedule the meeting using the first list and the second list.

A fifth aspect of the present invention provides data processing system for scheduling a meeting, comprising a memory medium having instructions; a bus coupled to the memory medium; and a processor coupled to the bus that when executing the instructions causes the data processing system to: a receive a set of meeting characteristics; receive a first list having a set of mandatory meeting characteristics that are required for the meeting, an order of the set of mandatory meeting characteristics in the first list dictating their prioritization when scheduling the meeting; receive a second list having a set of preferred meeting characteristics that are optional for the meeting, an order of the set of preferred meeting characteristics in the second list dictating their prioritization when scheduling the meeting; and schedule the meeting using the first list and the second list.

A sixth aspect of the present invention provides a search engine, comprising: a module for receiving a set of search criteria for a search; a module for receiving a first list having a set of mandatory search criteria that are mandatory for the search, an order of the set of mandatory search criteria in the first list dictating their prioritization; a module for receiving a second list having a set of preferred search criteria that are optional for the search, an order of the set of preferred search criteria in the second list dictating their prioritization when searching; and a module for performing the search using the set of search criteria, the first list and the second list.

A seventh aspect of the present invention provides a search method, comprising: receiving a set of search criteria for a search; receiving a first list having a set of mandatory search criteria that are mandatory for the search, an order of the set of mandatory search criteria in the first list dictating their prioritization; receiving a second list having a set of preferred search criteria that are optional for the search, an order of the set of preferred search criteria in the second list dictating their prioritization when searching; and performing the search using the set of search criteria, the first list and the second list.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative scheduler interface according to the present invention.

FIG. 2 depicts another view of the scheduler interface of FIG. 1 according to the present invention.

FIG. 3 depicts another view of the scheduler interface of FIG. 1 according to the present invention.

FIG. 4 depicts a result interface originating from a search using scheduling criteria set forth in FIGS. 1-3 according to the present invention.

FIG. 5 depicts the result interface of FIG. 4, according to the present invention.

FIG. 6 depicts another view of the result interface of FIG. 4, according to the present invention.

FIG. 7 depicts another view of the scheduler interface of FIG. 1 according to the present invention.

FIG. 8 depicts another view of the scheduler interface of FIG. 1 according to the present invention.

FIG. 9 depicts another view of the scheduler interface of FIG. 1 according to the present invention.

FIG. 10 depicts a more specific computerized implementation according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Illustrative Embodiment

II. Computerized Implementation

### I. General Description

As mentioned above, scheduling meetings is one of the most common tasks. Many of the current calendaring software programs allow multiple criteria when scheduling meetings: Date, Time, Meeting length, Critical and Optional Attendees, Rooms, Resources, even color coding of categories for types of meetings. What is missing is a ranking system for meeting criteria. We've come up with a new concept of ranking whereby calendar users will be allowed to prioritize a variety of meeting attributes. For prioritizing their meeting requirements, users can place meeting requirements into one of two lists: “Must/mandatory” and “preferred.” The system will then search for meeting times that satisfy the user's prioritization. The search produces a ranked result set of meeting alternatives. Users see percentage rankings of how well the various meeting alternatives satisfy their Must and preferred requirements, and a summary of proposed meeting logistics for each alternative. In conducting the search, the system will have comprehensively consulted with all external systems which may be involved in meeting scheduling, which saves much time for the user by providing a one-stop shopping experience. The user then can follow-up by choosing the most suitable alternative from the results set to actually schedule the meeting.

It should be understood that although an illustrative embodiment and some of the claims below are directed towards the scheduling of a meetings, the teachings of the present invention could be implemented with respect to any type of search engine/technology.

### II. Illustrative Embodiment

Search engine techniques are applied to the process of meeting scheduling, i.e. the user enters some meeting parameters and then asks a search engine to look for a list of meeting alternatives that satisfy the parameters. As a result of the search, the user is presented with a summary list of alternatives, and the user can also get further details on each suggested alternative. Search results are listed in an order which presents most desirable results at the top of the list, with less desirable results following. The results are ranked according to how well each alternative meets the user's requirements. Ultimately the user can choose one of the alternatives, and take quick action to commit the scheduling of the meeting according to the selected logistics. Our approach bypasses extensive numbers of steps to deal with typical scheduling conflicts. Our approach is to be proactive to provide a list of meeting alternatives. The user can pick and choose from the alternatives, as well as clearly see how well (or badly) each meeting alternative will satisfy the user's comprehensive meeting requirements. The rating system associated with each suggested alternative gives the user an immediate evaluation about the viability of the choice, and details can be viewed which give full disclosure on possible points of failure.

The approach of the present invention also relaxes requirements for fully specifying the usual meeting parameters, for example meeting time or meeting location. This approach allows for improved flexibility for the user. The user provides input to the search engine, and the search engine automatically handles missing parameters.

This search engine system will comprehensively and seamlessly consult with other systems, such as conference room scheduling, in order to streamline the amount of work required for the user. Our approach is to seamlessly connect such external systems to our search engine. Similarly to searching databases that contain attendee free-time, the search engine will search databases containing conference room logistics. As per our objective stated earlier to relax user input requirements, the scheduler can operate in the absence of a specific room request—the scheduler will always propose an appropriate conference room for any meeting alternative, therefore the user does not need to spend any time at all consulting an external conference room scheduling database.

The scheduler allows the user to prioritize the search parameters. The search engine applies the user's prioritization to determine best fit scheduling alternatives. The user can prioritize items within a mandatory list. The user's ordering of the mandatory list will determine the behavior of the search engine. The ordering of the mandatory list is especially helpful in scenarios where all the requirements cannot be satisfied and the search engine must look for Best Fit meeting arrangements.

Example: Suppose the user wants to schedule a meeting on Monday with a large group of people. The mandatory list has 2 items

Date: Monday

Critical people available

This mandatory list ordering indicates that the Monday date is highest priority. This is useful for a scenario where the user is going out of town on Tuesday and has no choice but to hold the meeting on Monday, hopefully at a time which can include the largest number of invitees as possible.

Example: Suppose the user wants to schedule a meeting on Monday with a large group of people. The mandatory list has 2 items

Critical people available

Date: Monday

This mandatory list ordering indicates that the people availability is highest priority. The user really, really wants this meeting on Monday. But assume the invitees are not all available on Monday. In this case, the search engine's Best Fit alternatives might include moving the meeting to Tuesday in order to accommodate all of the attendees.

In addition to the mandatory list, the scheduler includes a preferred list. The preferred list is populated with additional user requirements that should be considered by the search engine once all the mandatory list requirements have been satisfied. As with the mandatory list, the user can prioritize items in the preferred list. Scheduling conflicts are very typical, and the best fit approach helps the user deal with these typical error scenarios. The user controls the process by providing the scheduler with concrete guidelines for how to conduct the best fit search. Therefore the results will be highly tailored to the user's desires, saving the user much time to find best fit alternatives.

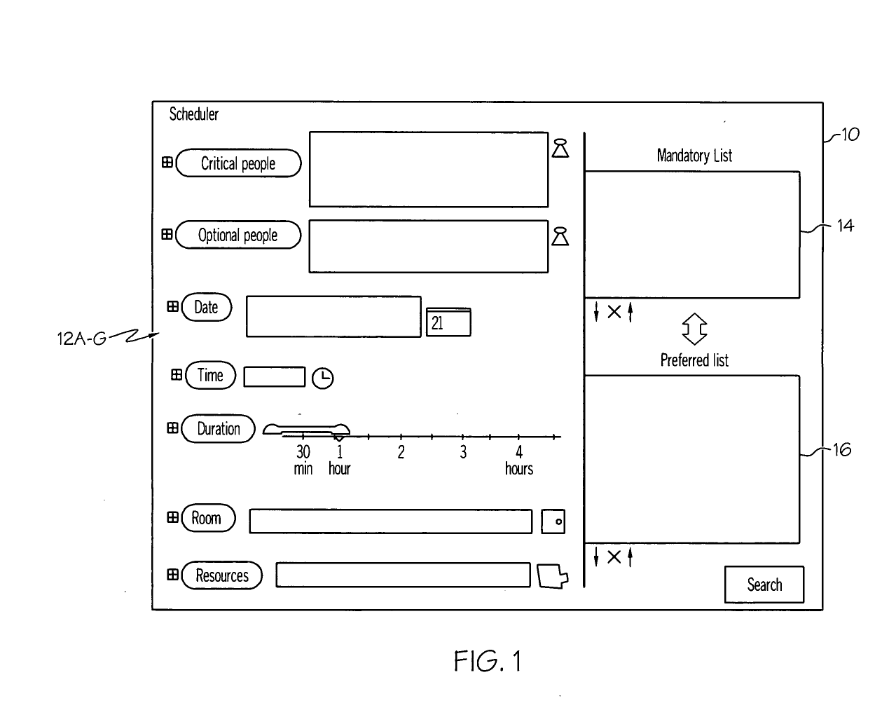

The present invention also provides a user interface that can accommodate a user who does not want to actively manage priorities. As per this solution, as the user enters information for the meeting scheduler, the user is continuously viewing the contents of the mandatory and preferred lists. An illustrative user interface 10 is shown in FIG. 1. User interface 10 can be organized into a left side and a right side. The left-hand side of user interface provides controls for entering meeting specifications 12A-F, such as the date, time, etc. The right-hand side of the user interface displays mandatory list 14 and preferred list 16. It is typically intended that the user will take action to move requirements to either mandatory list 14 or preferred list 16 as part of the scheduling procedure. However, for a less active user (or a user who is not skilled in the user interface), there can be a configured mode of operation for the scheduler whereby mandatory list 14 is automatically populated on behalf of the user. In this mode of operation, the scheduler takes note of the order in which the user enters items into the user interface. As the user transitions from one requirement to the next in the user interface, the user interface takes note of the requirement just entered and automatically places that requirement at the end of mandatory list 14. For a fully non-savvy user who might simply fill out the information from top to bottom, the effect is that mandatory list 14 will reflect the ordering of the calendar form itself, which is providing a reasonable default ordering for the search (people first, then date, then time, etc).

One purpose of this feature is to allow the user interface to share the same advantages as simple scheduling products. A conventional scheduling product can be straightforward to use, supplying fields for the user to enter requirements and a button or action to complete the operation. By finding ways to auto-manage the sophisticated features of our invention, we allow for a simple use model. It is advantageous to provide visual feedback to the user (i.e. populating mandatory list 14), to show the user how the product is going to work, even if the user may not be aware of or be actively using all advanced functionality.

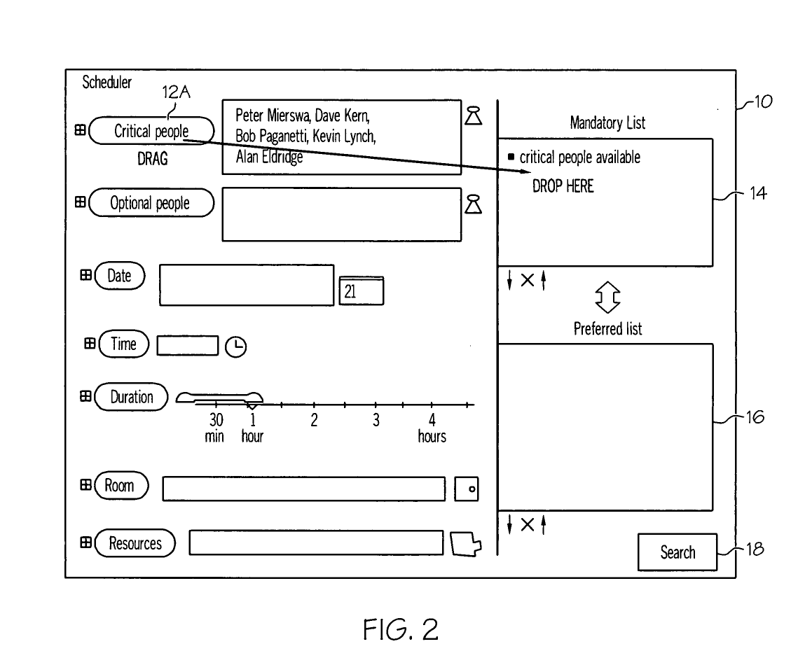

For the purposes of this example, this disclosure will follow the progress of a user who wants to schedule a meeting using FIGS. 2-6, and begins to enter in requirements using interface 10. As shown in FIG. 2, the user enters in the names of the people to invite on the left hand side in the “Critical People” area 12A. This can be done by clicking on the (poorly drawn) person picker next to the critical people list, or the names can be entered in via typing. The user indicates that 5 people are critical to attend this meeting. The user then positions the mouse on the “Critical People” circle and drags and drops on mandatory list 14. The drop operation on mandatory list 14 puts an entry into mandatory list 14 which says “critical people available”. Being in the top spot on mandatory list 14, this means that the availability of the people is top priority. That is, an order of mandatory list dictates a priority.

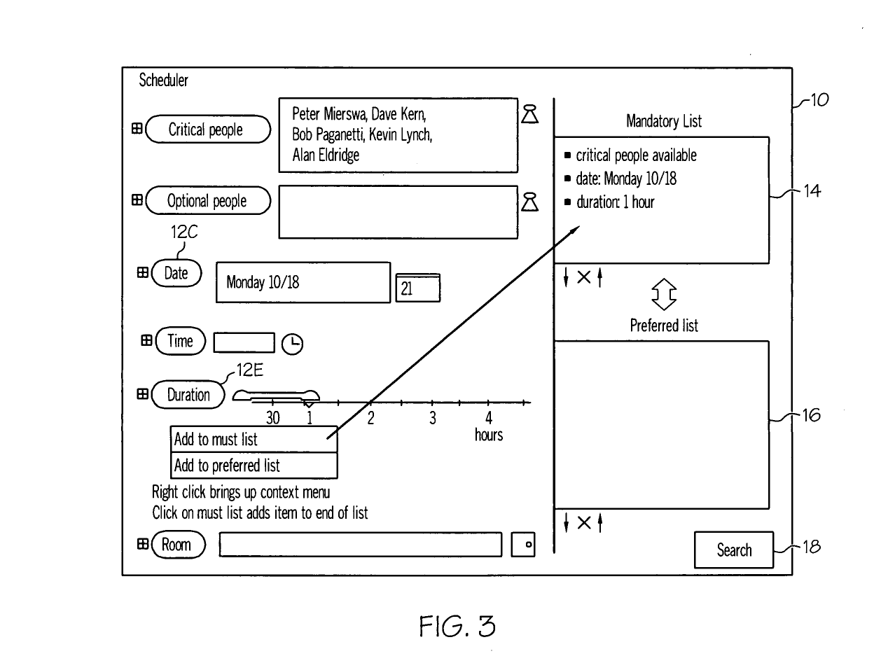

Referring now to FIG. 3, the user will next consider the date. Along these lines the user can enter in the date in “Date” area 12C. In selecting a date, any known technology can be used, such as calendar entry drop-down boxes, a date picker, etc. As further shown, the user has dragged and dropped the date into mandatory list 14 as shown. Next, the user considers the meeting duration. As depicted, the user has selected a meeting duration of 1 hour via duration 12E. Assume that the user wants to add the duration to mandatory list 14. For simplicity, we have stated previously that this will be done by drag and drop. However, here we note that it will always also be possible to use keyboard actions instead. In particular, the user can either drag and drop onto mandatory list 14, or can use a context sensitive menu for adding to mandatory list 14. The context sensitive menu will appear if the user right clicks on a circle (in this case the Duration circle 12E) or uses a keyboard accelerator. Note in FIG. 3 that the context sensitive menu allows the user to move the duration requirement to either mandatory list 14 or to preferred list 16.

In general the format of the items in mandatory list 14 is controlled by the scheduling tool itself, and the user does not directly type entries into the list. Because the scheduling tool is exerting control over the list, the tool is able to prevent inconsistencies in the list. (For example, it may not make sense to allow the user to define a list of Optional people that are prioritized ahead of the Critical people.). Regardless, assume the user is now done populating mandatory list 14 and selects the “Search” button 18 at the bottom right. Next, the user will see some results, based on the priority of mandatory list 14, and how well those requirements can be satisfied. The results are typically presented in a list. Each item in the list represents an alternative for scheduling this meeting. The summary information for each alternative includes:

Ranking (e.g. 100%)

Day/date (e.g. Monday 10/18)

Time range (e.g. 8:30 AM-9:30 AM)

Room assignment (e.g. Bermuda)

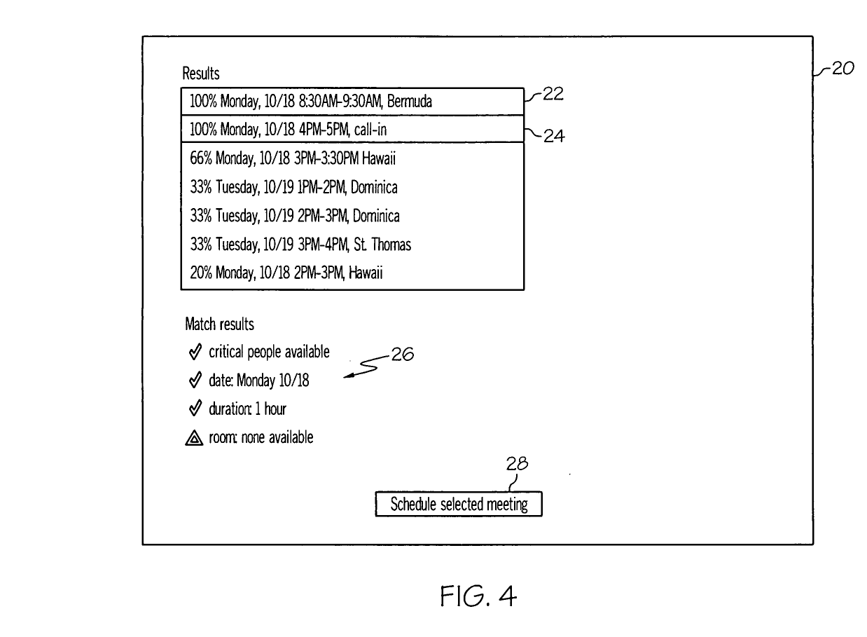

The entries are arranged in the list with the best meeting alternatives being listed first and subsequent listings of worse alternatives. The ranking of each alternative is an assigned percentage. An example of a result list/interface 20 is shown in FIG. 4. As depicted, the best fit with the scheduling priorities is the top item 22 in the list 20, which suggests an 8:30 meeting time. The 8:30 meeting time is given 100% ranking, because the 8:30 meeting time meets all mandatory list 14 requirements shown in FIG. 3.

For any item in results list 20, the user can select the item to get further details. FIG. 4 also shows the details 26 for the second item 24 in list 20. Specifically, the user has clicked on the item 24 in the list to show the details 26 (details appear in the bottom half of the screen). The reason that the user is investigating the second choice can be because the user realizes that 8:30 is a tough time to hold a meeting, and in particular, the user realizes there's no way that this particular group of people will actually show up for an early 8:30 meeting. As such the user has clicked on second item 24 in the list to find out more about the second possibility. The details 26 show how well this particular alternative satisfies the user's requirements, by restating those requirements in the details area.

As shown in the details 26, the only potential problem with the 4 PM suggested time is that there isn't an available room. The tool has automatically pointed out a possible point of failure. Even though the user didn't ask for a room explicitly, the scheduler automatically looked for a room by consulting an external database. However, since the user didn't list the room as a priority in mandatory list 14, the fact that there was no room available did not impact the ranking. From the scheduler's point of view, maybe it's fine not to have a room (perhaps everyone will call into the meeting or perhaps the meeting can take place in someone's office). If the user is indeed fine with this no-room situation, the user can select the “Schedule Selected Meeting” button 28 to initiate the actual scheduling of the meeting.

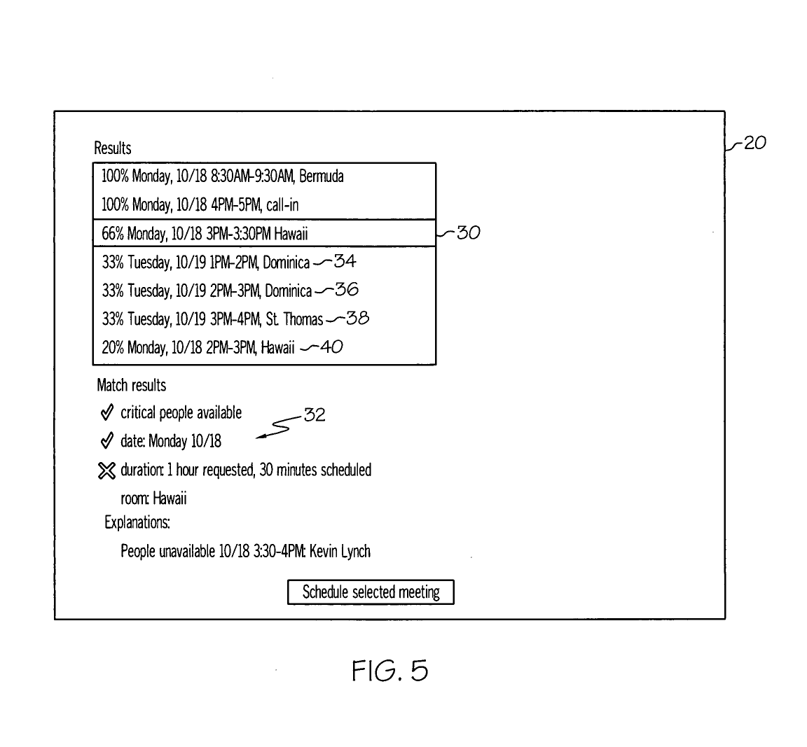

Assume now that the meeting will involve a complex discussion with proposals to be hand-drawn on a white board. Therefore, a call-in meeting will not be ideal and the user investigates the next item 30 in list 20 as shown in FIG. 5. This choice gets a 66% rating as shown, because the top 2 priorities from mandatory list 14 are satisfied by this item, but the third priority (duration) cannot be satisfied. The details 32 show that it's possible to get everyone together on the selected day, as long as the meeting is confined to 30 minutes (instead of an hour). The reason for the best fit adjustment is shown (Kevin Lynch unavailable for the full hour). If the user thinks Kevin needs to be there and the meeting can't go on without Kevin, it may be a good compromise to meet for a half hour instead of for an hour.

From the example shown in FIG. 5, it now appears that the user has run out of good possibilities for scheduling on the requested Monday date. Because the availability of the people was top priority in mandatory list 14, the scheduler shows a few of possibilities for moving the meeting to Tuesday. The Tuesday possibilities 34, 36, and 38 are higher in the list 20 than the last item in the list 40. The last item in the list 20 proposes meeting without all the requested people. It is last in the list 20 because the people were stated as highest priority in mandatory list 14.

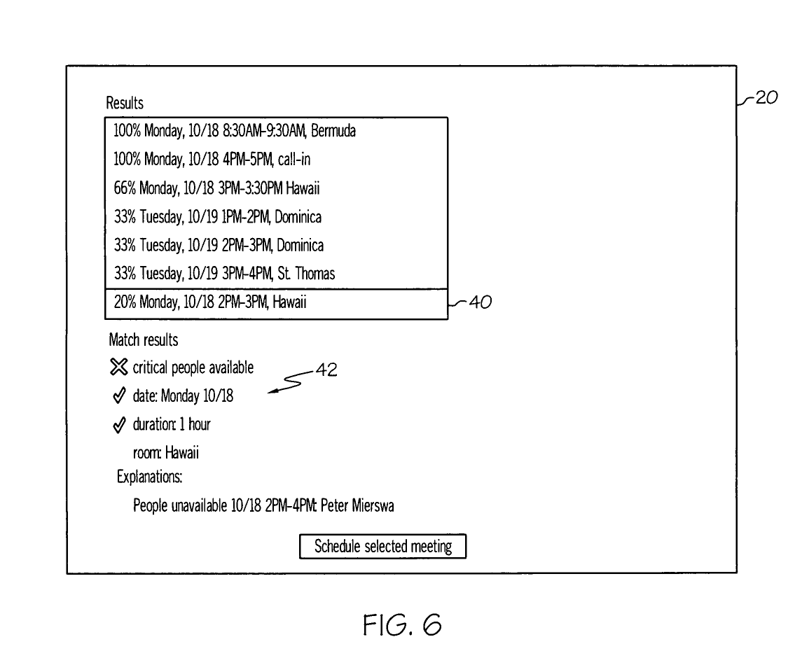

FIG. 6 depicts details 42 revealed when this last alternative 40 is selected. As shown, everybody except for Peter Mierswa is available at the Monday 2 PM time. If the user decides that Peter could be optional rather than critical for the meeting, this time might be selected. But it the user's initial prioritization was correct and the availability of people was indeed most critical, then the alternative to conduct the meeting without all of the invitees earns its last place finish in the alternatives list.

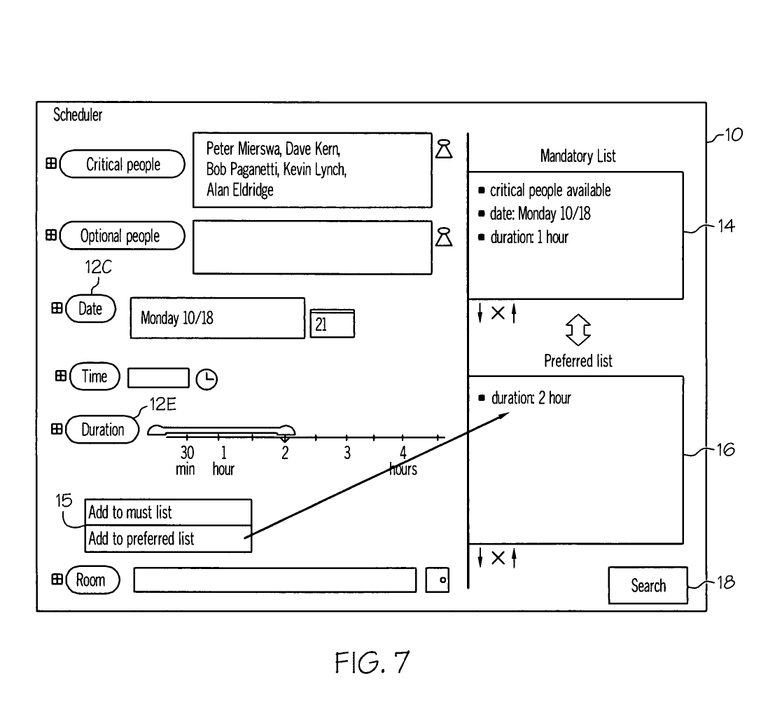

Now that the operation of mandatory list 14 and the impact of user priorities on the results list have been described, this disclosure will describe the operation and impact of preferred list 16 beginning with FIG. 7. Assume the user planning this meeting decides that a 2 hour meeting would be better than having a one hour meeting. Minimally the user wants a 1 hour meeting, but if it's possible to schedule a 2 hour meeting then that would be better. This preference can be reflected using duration control 12E and by creating a new entry in preferred list 16 as shown in FIG. 7. As mentioned above, characteristics/criteria can be placed into a list 14 or 16 using any known technique such as drag and drop techniques, selection buttons 15, etc. When similar items are added to both mandatory list 14 and preferred list 16, the Scheduler tool of the present invention will enforce consistency. In this case duration is listed both as mandatory and as a preference. This case has consistency because satisfying the 2 hour duration preference will also satisfy the 1 hour duration mandatory requirement (which is understood to indicate a 1 hour minimum in this scenario). If the user attempts to define the converse (e.g. a mandatory duration of 2 hours, and a preferred duration of 1 hour), then the tool user interface will prevent the entering of those invalid nonsensical combinations into the lists 14 and 16.

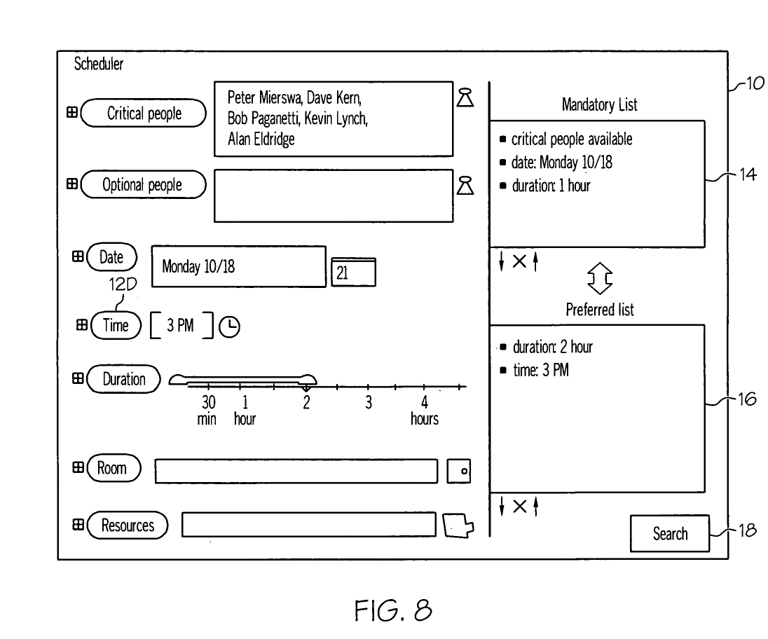

Referring now to FIG. 8, assume the user really wants to have the meeting at 3 PM if possible (e.g., designated using time area/control 12D). However, having the meeting at 3 PM is not as important as scheduling the meeting for 2 hours. Therefore, the 3 PM preference is placed after the 2 hour duration preference.

When the user clicks on Search button 18, the results will: show ranked meeting alternatives for satisfying all mandatory list 14 items in their priority order; if there are a number of alternatives that would satisfy all mandatory list 14 items, then the priority order of preferred list 16 is also considered. There could be many items in preferred list 16. The ideal match to be recommended to the user in the results area would satisfy all mandatory list 14 items AND satisfy all preferred list 16 items. The ranking will reflect how well the priorities are satisfied (perhaps might optionally display a separate percentage for mandatory list 14 percent satisfied vs. preferred list 16 percent satisfied). The details of the results will clearly show which mandatory and preferred items have been satisfied. Presumably preferred list 16 may not be consulted at all if there are no alternatives to satisfy all of the mandatory items.

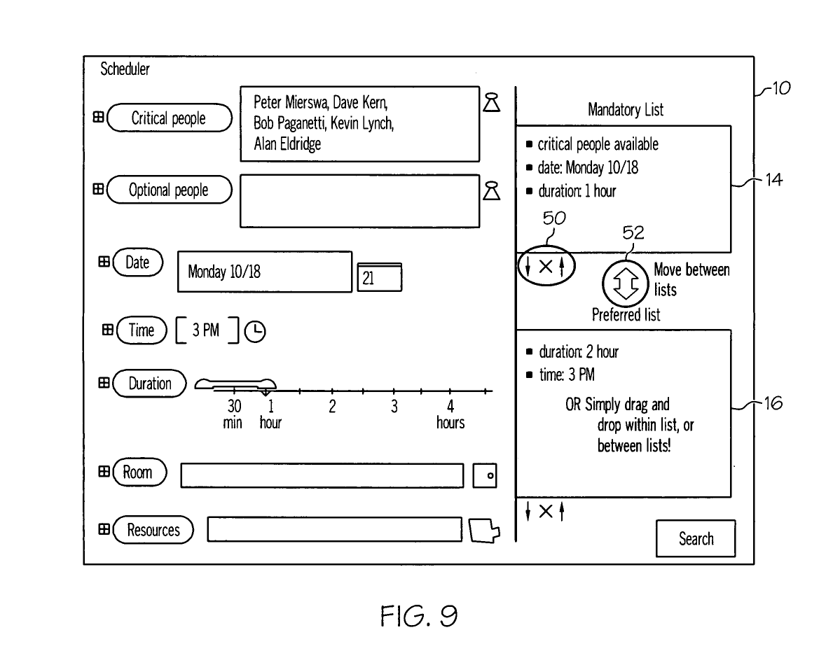

It should be reiterated that the user controls the search by giving guidelines to the search engine. Therefore the user should have the capability to manage the mandatory list 14 and preferred list 16, to reorder requirements and to remove requirements. Thus, FIG. 9 depicts controls 50 and 52 for changing the order of characteristics/criteria in lists 14 and 16, as well as for moving characteristics/criteria between lists 14 and 16.

It should be understood that interface 10 is intended to be illustrative only and various other variations are possible, for example, dots in interface 10 could be replaced with icons that are representative of the item to which they pertain (e.g., a clock icon could be placed next to a time requirement in a list).

For the less-active or knowledgeable user who does not want to directly manage priorities or to differentiate between mandatory requirements and preferred criteria, there can be a configured mode of operation for the scheduler whereby mandatory list 14 is automatically populated on behalf of the user. This mode of operation allows an extremely simple use model. In this mode of operation, the scheduler takes note of the order in which the user enters items into the user interface. As the user transitions from one requirement to the next in the user interface, the user interface takes note of the requirement just entered and automatically places that requirement at the end of mandatory list 14. Here's an example of how it might operate:

User enters the date into the user interface.

User transitions from the date control to the time control.

Scheduler assumes the user intends for the date (i.e., the first item completed) to be highest priority within mandatory list 14, therefore the scheduler automatically places the date item as the first item of mandatory list 14. User completes the time specification and transitions to the room control.

Scheduler automatically appends the completed time requirement onto the end of mandatory list 14.

This continues as the user accesses the various controls in the user interface. Eventually the user is done providing requirements and requests that the search begins, at which point the scheduler moves the final item of the user's requirements (e.g. the room requirement) to mandatory list 14 and starts the search. In this mode of operation, the user is still able to modify items as needed. Modifying items is done simply by changing the requirements on the left-hand side controls. In this mode, there will be a one-to-one correspondence with items appearing on the left-hand side, and items automatically placed into mandatory list 14. The controls which otherwise manage mandatory list 14 and preferred list 16 will be disabled in this mode of operation. One exception might involve the control that moves items between mandatory list 14 and preferred list 16. This control could be active by default rather than disabled (i.e. mandatory list 14 is always the automatically populated list, but perhaps the user still can at any time move items from mandatory list 14 to the preferred List, as long as there continues to be a one-to-one correspondence between items on the left-hand side and the items that appear on the right-hand side). The switch to turn on this option could be presented as part of the Scheduler configuration, perhaps represented as follows:
(Yes/no) Treat entered criteria as mandatory requirements by auto-inserting into mandatory list 14.

The user should be able to toggle this setting to change the default behavior of the user interface.

### III. Computerized Implementation

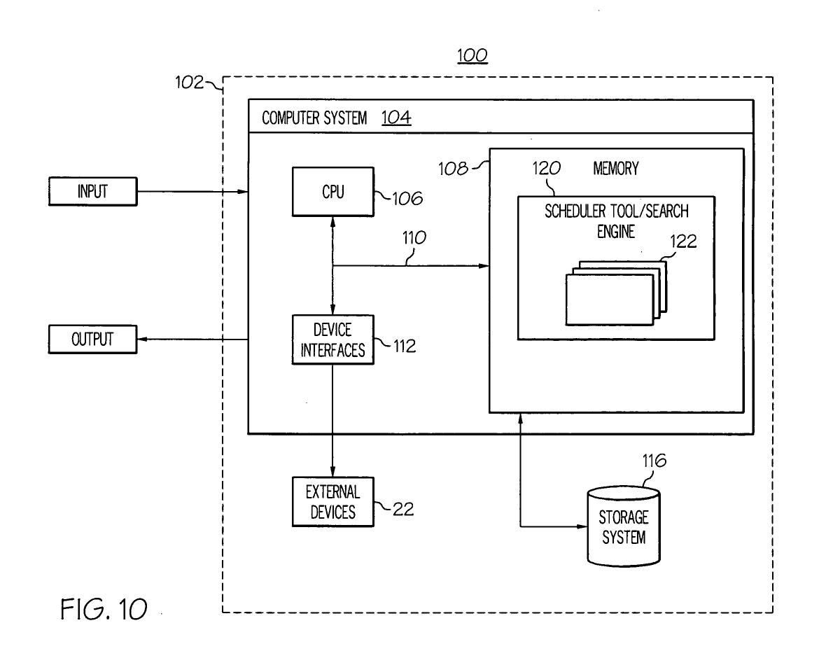

Referring now to FIG. 10, a computerized implementation 100 of an embodiment of the present invention is shown. As depicted, implementation 100 includes computer system 104 deployed within a computer infrastructure 102. Computer system 104 is intended to represent the broker as described above. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others. In addition, although computer system 102 is depicted as a single computer system, this need not be the case, rather, computer system 104 could be implemented as multiple computer systems.

As shown, computer system 104 includes a processing unit 106, a memory 108, a bus 110, and device interfaces 112. Further, computer system 104 is shown external devices 114 and storage system 116 that communicate with bus via device interfaces. In general, processing unit 106 executes computer program code, such as scheduler tool/search engine 120, which are stored in memory 108 and/or storage system 116. While executing computer program code, processing unit 106 can read and/or write data to/from memory 108, storage system 116, and/or device interfaces 112. Bus 110 provides a communication link between each of the components in computer system 104. Although not shown, computer system 104 could also include I/O interfaces that communicate with: one or more external devices such as a cash broker, a keyboard, a pointing device, a display, etc.; one or more devices that enable a user to interact with computer system 104; and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external device 114. Still further, it is understood that one or more additional components (e.g., system software, math co-processing unit, etc.) not shown in FIG. 10 can be included in computer system 104.

Storage system 116 can be any type of system capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is scheduler tool/search engine 120, which includes a set (at least one) of modules 122. The modules generally provide the functions of the present invention as described herein such as: configuring scheduler tool/event program 120; designating/selecting characteristics/criteria; making selections (e.g., of options, characteristics, criteria, of items, buttons, etc.); manipulating lists, displaying (e.g., interfaces, selections, options, results, details, etc.); performing searches; etc.

While shown and described herein as a solution for searching (e.g., to schedule a meeting), it is understood that the invention further provides various alternative embodiments. For example, in one embodiment, the invention provides a computer-readable/useable medium that includes computer program code to enable a computer infrastructure to provide the functionality described herein. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 10) and/or storage system 116 (FIG. 10) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide the functions described herein. In this case, the service provider can create, maintain, and support, etc., a computer infrastructure, such as computer infrastructure 102 (FIG. 10) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for searching and/or scheduling a meeting. In this case, a computer infrastructure, such as computer infrastructure 102 (FIG. 10), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 10), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or processing device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code mandatory be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for scheduling a meeting, comprising:
receiving a set of meeting characteristics;
receiving a first list having a set of mandatory meeting characteristics that are required for the meeting, an order of the set of mandatory meeting characteristics in the first list dictating their prioritization when scheduling the meeting;
receiving a second list having a set of preferred meeting characteristics that are optional for the meeting, an order of the set of preferred meeting characteristics in the second list dictating their prioritization when scheduling the meeting; and
scheduling the meeting using the first list and the second list.

2. The method of claim 1, the scheduling comprising scheduling the meeting so that all mandatory meeting characteristics are fulfilled and any available preferred meeting characteristics are fulfilled.

3. The method of claim 1, further comprising suggesting alternative meeting characteristics when any of the set of mandatory meeting characteristics is not available.

4. The method of claim 3, the alternative meeting characteristics being presented in an order of how well the alternative meeting characteristics fulfill the scheduling user's prioritization of the mandatory meeting characteristics in the first list.

5. The method of claim 1, further comprising suggesting alternative meeting characteristics when any of the set of preferred meeting characteristics is not available.

6. The method of claim 5, the alternative meeting characteristics being presented in an order of how well the alternative meeting characteristics fulfill the scheduling user's prioritization of the preferred meeting characteristics in the second list.

7. A system for scheduling a meeting, comprising:
a module for receiving a set of meeting characteristics;
a module for receiving a first list having a set of mandatory meeting characteristics that are required for the meeting, an order of the set of mandatory meeting characteristics in the first list dictating their prioritization when scheduling the meeting;
a module for receiving a second list having a set of preferred meeting characteristics that are optional for the meeting, an order of the set of preferred meeting characteristics in the second list dictating their prioritization when scheduling the meeting; and
a module for scheduling the meeting using the first list and the second list.

8. The system of claim 7, a module for the scheduling being configured to scheduling the meeting so that all mandatory meeting characteristics are fulfilled and any available preferred meeting characteristics are fulfilled.

9. The system of claim 7, further comprising a module for suggesting alternative meeting characteristics when any of the set of mandatory meeting characteristics is not available.

10. The system of claim 9, the alternative meeting characteristics being presented in an order of how well the alternative meeting characteristics fulfill the scheduling user's prioritization of the mandatory meeting characteristics in the first list.

11. The system of claim 7, further comprising a module for suggesting alternative meeting characteristics when any of the set of preferred meeting characteristics is not available.

12. The system of claim 11, the alternative meeting characteristics being presented in an order of how well the alternative meeting characteristics fulfill the scheduling user's prioritization of the preferred meeting characteristics in the second list.

13. A computer readable medium containing a program product for scheduling a meeting, the computer readable medium comprising program code for causing a computer system to comprising:
receive a set of meeting characteristics;
receive a first list having a set of mandatory meeting characteristics that are required for the meeting, an order of the set of mandatory meeting characteristics in the first list dictating their prioritization when scheduling the meeting;
receive a second list having a set of preferred meeting characteristics that are optional for the meeting, an order of the set of preferred meeting characteristics in the second list dictating their prioritization when scheduling the meeting; and
schedule the meeting using the first list and the second list.

14. The computer readable medium of claim 13, the computer readable medium further comprising program code for causing the computer system to schedule the meeting so that all mandatory meeting characteristics are fulfilled and any available preferred meeting characteristics are fulfilled.

15. The computer readable medium of claim 13, the computer readable medium further comprising program code for causing the computer system to suggest alternative meeting characteristics when any of the set of mandatory meeting characteristics is not available.

16. The computer readable medium of claim 15, the alternative meeting characteristics being presented in an order of how well the alternative meeting characteristics fulfill the scheduling user's prioritization of the mandatory meeting characteristics in the first list.

17. The computer readable medium of claim 13, the computer readable medium further comprising program code for causing the computer system to suggesting alternative meeting characteristics when any of the set of preferred meeting characteristics is not available.

18. The computer readable medium of claim 17, the alternative meeting characteristics being presented in an order of how well the alternative meeting characteristics fulfill the scheduling user's prioritization of the preferred meeting characteristics in the second list.

19. A method for deploying an application for scheduling a meeting, comprising:
providing a computer infrastructure being operable to:
receive a set of meeting characteristics;
receive a first list having a set of mandatory meeting characteristics that are required for the meeting, an order of the set of mandatory meeting characteristics in the first list dictating their prioritization when scheduling the meeting;
receive a second list having a set of preferred meeting characteristics that are optional for the meeting, an order of the set of preferred meeting characteristics in the second list dictating their prioritization when scheduling the meeting; and
schedule the meeting using the first list and the second list.

20. The method of claim 19, the computer infrastructure being further configured to schedule the meeting so that all mandatory meeting characteristics are fulfilled and any available preferred meeting characteristics are fulfilled.

21. A search method, comprising:
receiving a set of search criteria for a search;
receiving a first list having a set of mandatory search criteria that are mandatory for the search, an order of the set of mandatory search criteria in the first list dictating their prioritization;
receiving a second list having a set of preferred search criteria that are optional for the search, an order of the set of preferred search criteria in the second list dictating their prioritization when searching; and
performing the search using the set of search criteria, the first list and the second list.
